(19) United States
(12) Patent Application Publication
(10) Pub. No.: US 2026/0103099 A1
(43) Pub. Date: Apr. 16, 2026

(54) CHARGER

(71) Applicant: KABUSHIKI KAISHA TOYOTA JIDOSHOKKI, Aichi (JP)

(72) Inventors: Motoe YASHIMA, Aichi (JP); Satoshi ITO, Aichi (JP)

(73) Assignee: KABUSHIKI KAISHA TOYOTA JIDOSHOKKI, Aichi (JP)

(21) Appl. No.: 19/351,674

(22) Filed: Oct. 7, 2025

(30) Foreign Application Priority Data
Oct. 11, 2024 (JP) 2024-178941

(51) Int. Cl. B60L 53/22; B60L 53/16; B60L 53/18

(52) U.S. Cl. CPC B60L 53/22; B60L 53/16; B60L 53/18; B60L 2210/30

(57) ABSTRACT

A charger mounted on a vehicle includes a converting circuit that converts an AC power supplied from a charging equipment to a DC power and supplies the DC power to a battery of the vehicle, a supply circuit that supplies a DC power supplied from the charging equipment to the battery, a case in which the converting circuit and the supply circuit are accommodated, and a first connecting portion that is disposed in the case and to which a cable is connected. The supply circuit is provided on a first power line. The charger further includes a second connecting portion that is disposed in the case and from which the power supplied to the first connecting portion and passing through a second power line branching off from the first power line is output and a third connecting portion that is disposed in the case and connected to the converting circuit.

### CROSS-REFERENCE TO RELATED APPLICATION

This application claims priority to Japanese Patent Application No. 2024-178941 filed on October 11, 2024, the entire disclosure of which is incorporated herein by reference.

### BACKGROUND ART

The present disclosure relates to a charger.

There is a charger for charging a battery of a vehicle disclosed in International Patent Application Publication No. 2013-073491. The charger is mounted in a motor compartment in this vehicle. The charger has a housing and an inverter or the like disposed in the housing. A connector is disposed in a side wall of the housing of this charger. Cables are connected to the connector.

Some vehicles each have an AC charging port for vehicles to which an AC voltage is input from a charging station as a charging equipment outside the vehicle and a DC charging port for vehicles to which a DC voltage is input from the charging station, which are separately provided. In addition, some vehicles each have a common charging port that serves as the AC charging port and the DC charging port.

In a case of the vehicle with the AC charging port and the DC charging port provided separately, a wiring extending from the AC power charging port is connected to the charger through an AC connector. A wiring extending from the DC power charging port is connected to the charger through a DC connector. The charger has a converting circuit that corrects a power factor and performs AC/DC (Alternate Current/Direct current) conversion.

The AC voltage input from the AC charging port is supplied to the converting circuit through the AC connector. Then, the AC voltage is converted to a DC voltage by the converting circuit, and the converted DC voltage is supplied to the battery of the vehicle. The DC voltage input from the DC charging port is directly supplied to the battery of the vehicle through the DC connector without passing through the converting circuit. Thus, in the case of the vehicle with the AC charging port and the DC charging port provided separately, the charger requires the two connectors (AC connector and DC connector).

On the other hand, in a case of the vehicle with the common charging port that serves as the AC charging port and the DC charging port, since a wiring extending from the one charging port is connected to the charger, the charger only needs to have one connector. This charger has therein two paths: one for AC and the other for DC. When an AC voltage is input to the charger, the AC voltage is input to the above-described converting circuit through the path for AC and converted to the DC voltage by the converting circuit. After that, the converted DC voltage is supplied from the converting circuit to the battery. When a DC voltage is input to the charger, the DC voltage is supplied to the battery through the path for DC without passing through the above-described converting circuit.

Thus, the charger with the two connectors and the charger with the one connector have the same function, and these two chargers are represented in the same manner in a circuit diagram. However, since these two chargers have different power paths, these two chargers differ from each other in a shape of a circuit board, arrangement of parts, or the like. Furthermore, these two chargers significantly differ from each other in design for the circuit board, electronic components layouts, or the like inside the charger depending on differences in a position of the connector and in the power path inside the charger. Accordingly, commonality of these two chargers is difficult, which may cause a problem that designing costs and manufacturing costs of the charger are increased.

The present disclosure is made to solve the above-mentioned problem, and an object in one aspect is to provide a charger that is reduced in designing costs and manufacturing costs.

### SUMMARY

In accordance with an aspect of the present disclosure, there is provided a charger mounted on a vehicle. The charger includes a converting circuit that converts an AC power supplied from a charging equipment outside the vehicle to a DC power and supplies the converted DC power to a battery of the vehicle, a supply circuit that supplies a DC power supplied from the charging equipment to the battery, a case in which the converting circuit and the supply circuit are accommodated, and a first connecting portion that is disposed in the case and to which a cable is connected. The AC power or the DC power from the charging equipment outside the vehicle are supplied to the first connecting portion though the cable. The supply circuit is provided on a first power line that connects the first connecting portion to the battery. The charger further includes a second connecting portion that is disposed in the case and from which the power supplied to the first connecting portion and passing through a second power line branching off from the first power line is output and a third connecting portion that is disposed in the case and connected to the converting circuit.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a view for explanation of a state in which a charger according to a present embodiment is mounted on a vehicle;

FIG. 2 is a perspective view of a charger according to a comparative example;

FIG. 3 is a perspective view of the charger according to the present embodiment in a state in which a pair of harnesses is not attached to the charger;

FIG. 4 is a perspective view of the charger according to the present embodiment in a state in which the pair of the harnesses is attached to the charger;

FIG. 5 is a view for explanation that the pair of the harnesses is attached to the charger according to the present embodiment; and

FIG. 6 is a circuit diagram inside the charger according to the present embodiment.

### DETAILED DESCRIPTION OF THE EMBODIMENTS

The following will describe an embodiment according to the present disclosure in detail with reference to the drawings. Note that in the drawings, identical or substantially identical components have the same reference numerals and may not be reiterated.

### Vehicle and charger

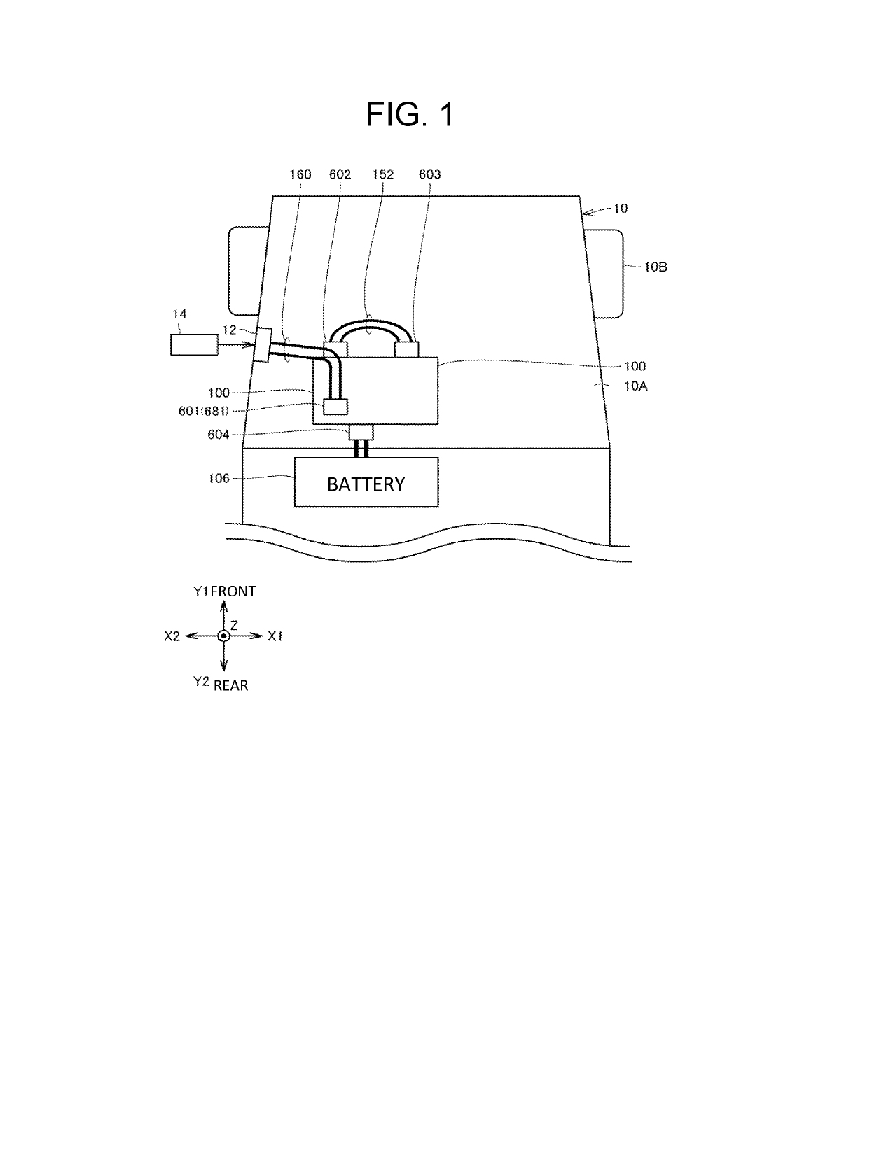

FIG. 1 is a view for explanation of a state in which a charger 100 according to the present embodiment is mounted on a vehicle 10. The vehicle 10 is an electric vehicle. The vehicle 10 mainly includes a charging port 12, a pair of cables 160, an engine compartment 10A, wheels 10B, and a battery 106. Note that in a case where the vehicle 10 is an electric vehicle, there is no engine on the vehicle 10, but the engine compartment 10A is formally referred to as the “engine compartment” in the present embodiment. Furthermore, the charger 100 is mounted in the engine compartment 10A. The charger 100 is electrically connected to the pair of the cables 160, the battery 106, and the like.

In the present embodiment, a height direction of the vehicle 10 is defined as a Z-axis direction. The Z-axis direction is a direction of gravity applied to the charger 100. A front-rear direction of the vehicle 10 is defined as a Y-axis direction. In particular, a front direction of the vehicle 10 is defined as a Y1-axis direction, and a rear direction of the vehicle 10 is defined as a Y2-axis direction. A left-right direction of the vehicle 10 is defined as an X-axis direction. In particular, a right direction of the vehicle 10 is defined as an X1-axis direction, and a left direction of the vehicle 10 is defined as an X2-axis direction. Furthermore, in a state in which the charger 100 is mounted on the vehicle 10, the Z-axis direction is the same as a height direction of the charger 100.

In a case where the vehicle 10 is charged in a charging facility, or the like, for example, a station-side connector extending from a charging station 14 as a charging equipment outside the vehicle 10 is inserted into the charging port 12. An alternating current (AC) voltage and a direct current (DC) voltage are applied to the charging port 12 from the charging station 14.

The voltage from the charging station 14 is supplied to the charger 100 through the charging port 12 and the pair of the cables 160. The charger 100 includes a first connector 601, a second connector 602, a third connector 603, a fourth connector 604, a pair of power lines 151, a pair of harnesses 152, and the like. Wiring extending from the fourth connector 604 is connected to the battery 106.

A cable connector 681 of the pair of the cables 160 through which the voltage from the charging station 14 is supplied is inserted into the first connector 601. Hereafter, a charging port on a vehicle side to which a DC voltage is input is referred to as the “DC charging port”, and a charging port on the vehicle side to which an AC voltage is input is referred to as the “AC charging port”. The charging port 12 of the present embodiment is a common charging port that serves as the AC charging port and the DC charging port. Accordingly, both the AC voltage and the DC voltage are input to the first connector 601.

When a DC voltage is input to the first connector 601, the DC voltage is greater than 0 V and 1000 V or less. When an AC voltage is input to the first connector 601, the AC voltage is greater than 0 Vrms (Voltage Root-Mean-Square) and 293 Vrms or less.

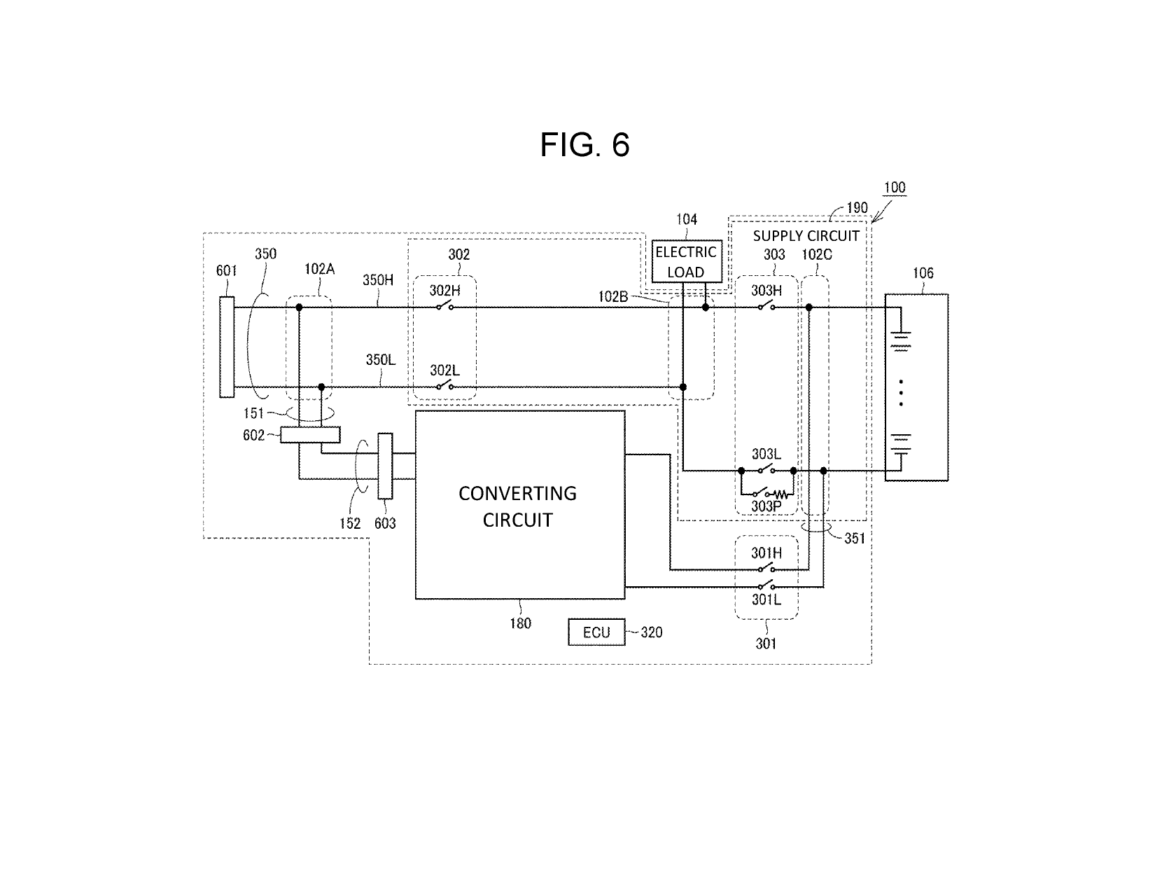

When an AC voltage is input to the first connector 601, the AC voltage is supplied to the second connector 602 through the pair of the power lines 151. The AC voltage is then input to the third connector 603 from the second connector 602 through the pair of the harnesses 152. The AC voltage is input to a converting circuit 180 (see FIG. 6) from the third connector 603.

The converting circuit 180 includes, for example, a circuit that corrects a power factor and performs AC-DC conversion, which is not particularly illustrated. That is, the converting circuit 180 converts the AC voltage input from the third connector 603 to a DC voltage and corrects the power factor, and then outputs the DC voltage. The converting circuit 180 typically includes an on-board charger.

The DC voltage output from the converting circuit 180 is supplied to the battery 106 through the fourth connector 604. For example, when an AC voltage is supplied from the charging station 14, the converting circuit 180 converts the AC voltage to a DC voltage and supplies the DC voltage to the battery 106.

In addition, when a DC voltage is supplied from the charging station 14, the charger 100 supplies the DC voltage to the battery 106 through the fourth connector 604. Note that as a modification, the converting circuit 180 of the charger 100 may adjust a value of the DC voltage supplied from the charging station 14 and supply the adjusted DC voltage to the battery 106.

A pair of power lines in the present embodiment includes a high voltage wiring through which a high voltage current flows and a low voltage wiring through which a low voltage current flows. Similarly, the pair of the harnesses 152 includes a high voltage harness through which a high voltage current flows and a low voltage harness through which a low voltage current flows.

### Charger in comparative example

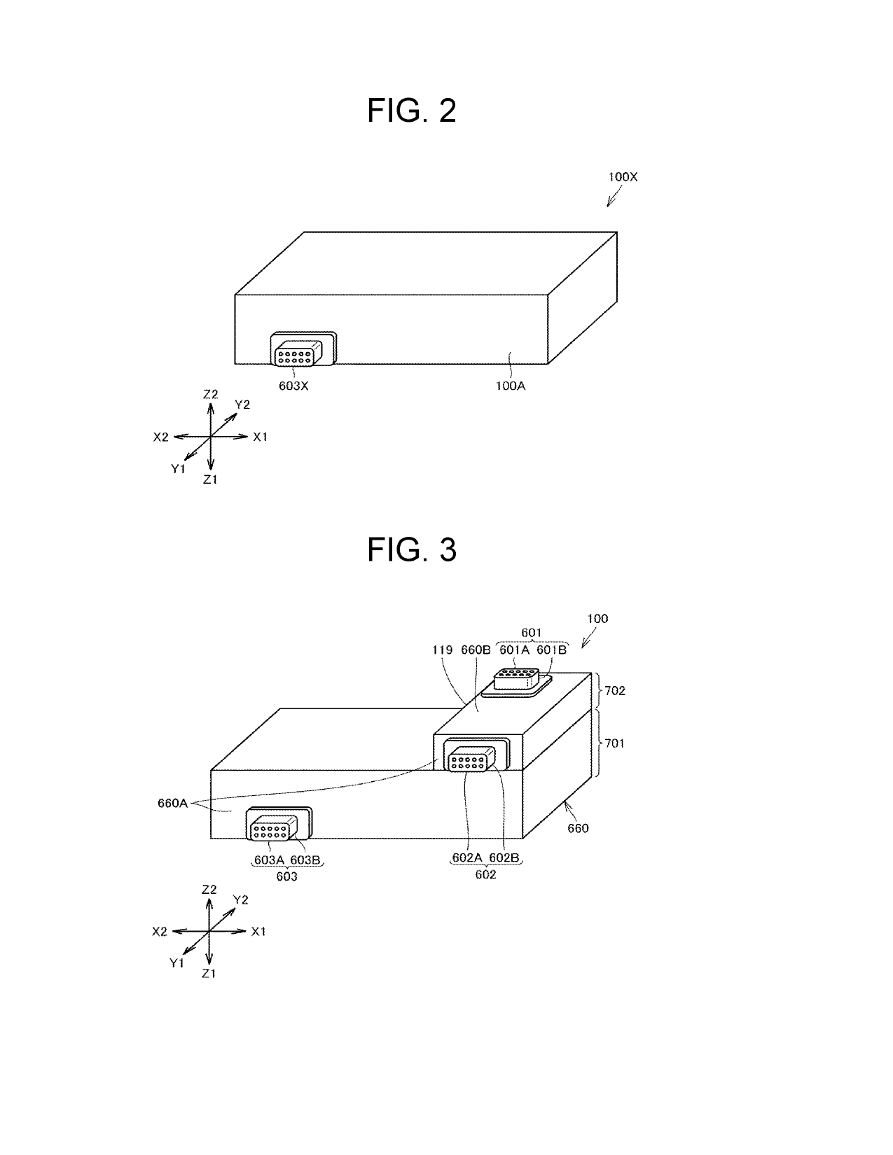

FIG. 2 is a perspective view of a charger 100X according to a comparative example. The charger 100X in the comparative example handles only AC charging, and is also referred to as the "existing charger 100X". A converting circuit, which is not illustrated, is accommodated in the charger 100X. In addition, a supply circuit, which will be described later, is not accommodated in the charger 100X. The charger 100X has a side surface 100A in which a connector 603X is disposed.

Here, the charger 100X is mounted in the engine compartment of the vehicle. In addition to the charger 100X, other components are also mounted in the engine compartment. In an example of FIG. 2, the connector 603X is disposed in the side surface 100A. Accordingly, when applying the charger 100X to the vehicle having the common charging port that serves as the AC charging port and the DC charging port, a designer of the charger or others may want to change a position of the connector 603X at which cables are connected in the above-described existing charger in consideration of presence of the other components.

However, when the charger with the connector 603X located at a new position is manufactured as a new charger, it is necessary to significantly change design for electronic component layouts or the like inside the existing charger, which may cause a problem that manufacturing costs of the new charger is increased. In addition, in order to apply the charger 100X to the vehicle having the common charging port that serves as the AC charging port and the DC charging port, also in a case where the supply circuit that is a path for a DC voltage when the DC voltage is supplied from the charging station 14 is provided in the charger 100X, there may be the same problem.

Accordingly, the present embodiment provides the charger 100 that is reduced in manufacturing costs in a case where the position of the connector 603X is changed and the supply circuit is provided in the existing charger 100X.

### Perspective view of charger in present embodiment

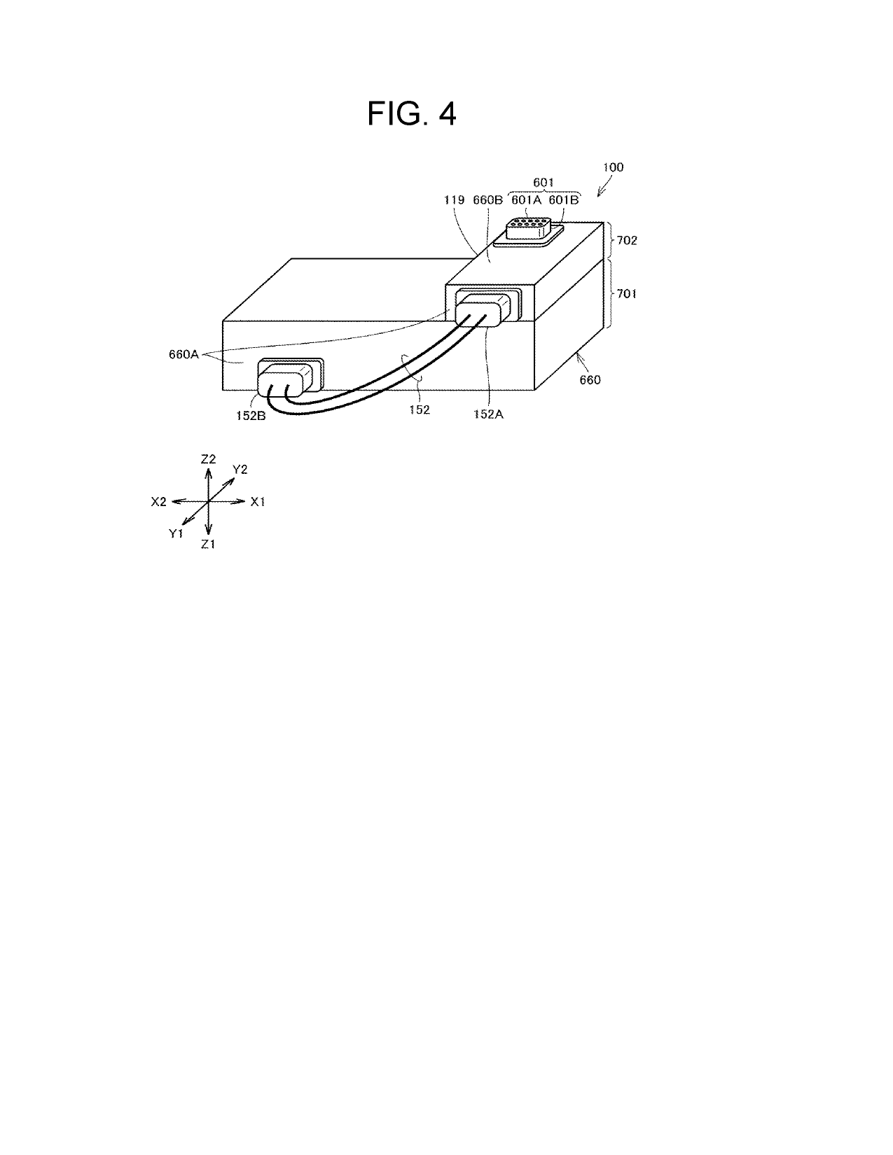

FIG. 3 is a perspective view of the charger 100 in a state in which the pair of the harnesses 152 (see FIG. 1) is not attached to the charger 100. FIG. 4 is a perspective view of the charger 100 in a state in which the pair of the harnesses 152 is attached to the charger 100.

The charger 100 includes a case 660, the first connector 601, the second connector 602, the third connector 603, and the converting circuit 180 (see FIG. 6) as illustrated in FIG. 6. The converting circuit 180, a supply circuit 190 (see FIG. 6), and the like are accommodated in the case 660. In addition, the charger 100 is a device that includes not only a first accommodating portion 701 but also a second accommodating portion 702. In an example of FIG. 3, the second accommodating portion 702 is positioned on the first accommodating portion 701. The first accommodating portion 701 is the existing charger 100X, and for example, may correspond to the charger 100X in the comparative example. The converting circuit 180 is accommodated in the first accommodating portion 701. The first accommodating portion 701 and the second accommodating portion 702 are separable from each other.

The case 660 has a multi-sided structure. The multi-sided structure is a structure including a first surface 660A and a second surface 660B different from the first surface 660A. In a mounted state (see FIG. 1) in which the charger 100 is mounted on the vehicle 10, the second surface 660B is an upper surface of the case 660 (charger 100).

In the above-described mounted state, the first surface 660A is a side surface of the case 660 (charger 100). In the example of FIG. 3, the first surface 660A is formed of a side surface of the first accommodating portion 701 and a side surface of the second accommodating portion 702 in the above-described mounted state, which are located on the same plane. Note that, as a modification, the side surface of the first accommodating portion 701 and the side surface of the second accommodating portion 702 may be different surfaces, which are not located on the same plane. For example, a step may be formed between the side surface of the first accommodating portion 701 and the side surface of the second accommodating portion 702. Even when such a step is formed, a combination of the side surface of the first accommodating portion 701 and the side surface of the second accommodating portion 702 is referred to as the first surface 660A.

The first connector 601 is disposed in the second surface 660B of the case 660 (second accommodating portion 702). The first connector 601 includes a first connecting portion 601A and a first connector-cover 601B covering the first connecting portion 601A. The first connector-cover 601B, a second connector-cover 602B described later, and a third connector-cover 603B described later are waterproof.

The first connecting portion 601A of the first connector 601 is formed so as to be connected to the pair of the cables 160 through which an AC power or a DC power are supplied from the charging station 14 outside the vehicle 10.

The second connector 602 is disposed in the first surface 660A of the case 660 (the second accommodating portion 702). The second connector 602 includes a second connecting portion 602A and the second connector-cover 602B covering the second connecting portion 602A. The second connecting portion 602A of the second connector 602 is formed so that the power supplied to the first connecting portion 601A is output to the pair of the harnesses 152 (see FIG. 1) through the second connecting portion 602A.

The third connector 603 is disposed in the first surface 660A of the case 660 (the first accommodating portion 701). The third connector 603 includes a third connecting portion 603A and the third connector-cover 603B covering the third connecting portion 603A. The third connecting portion 603A of the third connector 603 is connected to the converting circuit 180 and formed so that the power supplied from the second connecting portion 602A and passing through the harnesses 152 is supplied to the converting circuit 180 through the third connecting portion 603A.

In addition, the first connector 601, the second connector 602, and the third connector 603 are disposed in the case 660 so that a part of each of them is exposed to an outside of the charger 100. In the second accommodating portion 702, an area of the surface (second surface 660B) in which the first connector 601 is disposed is larger than that of the side surface of the second accommodating portion 702.

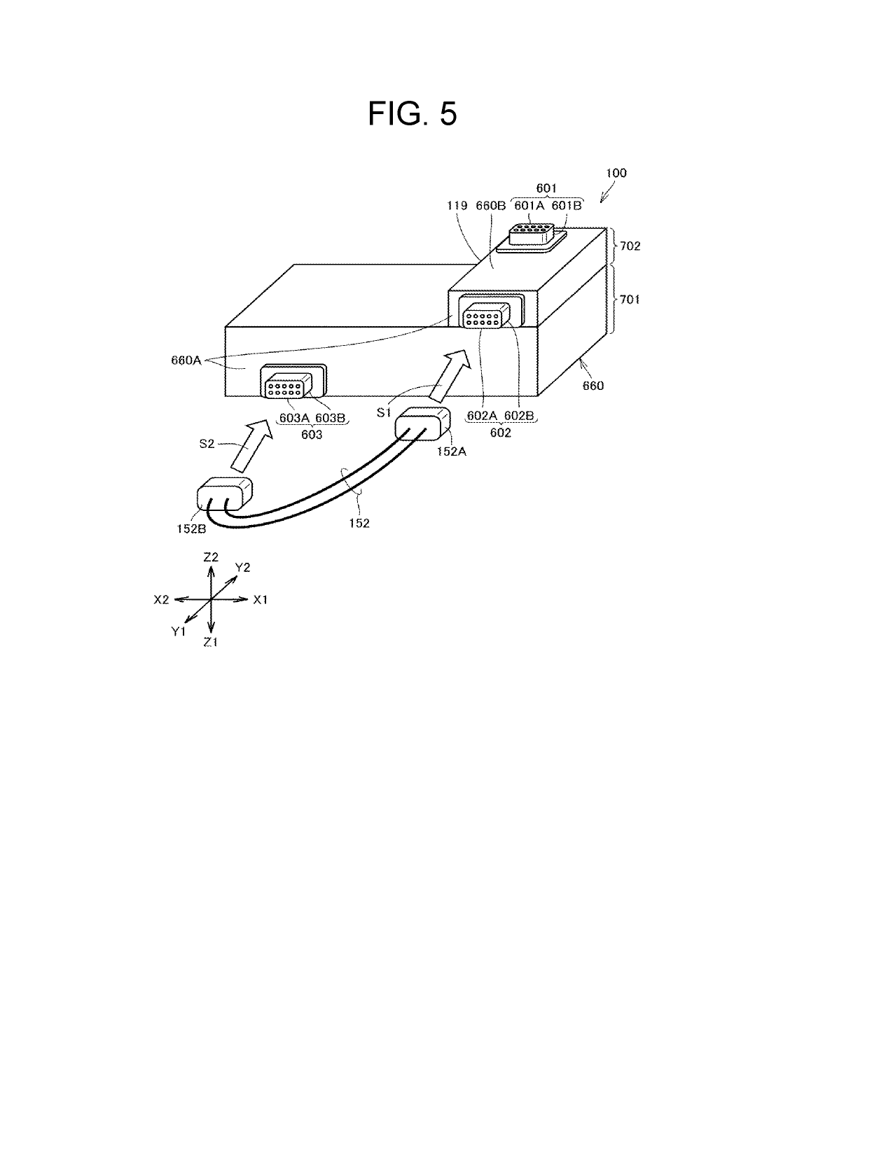

FIG. 5 is a view for explanation that the pair of the harnesses 152 is attached to the charger 100 without the pair of the harnesses 152. A first harness connecting portion 152A is formed at one ends of the pair of the harnesses 152. A second harness connecting portion 152B is formed at the other ends of the pair of the harnesses 152.

The first harness connecting portion 152A is connected to the second connecting portion 602A. The second harness connecting portion 152B is connected to the third connecting portion 603A. Here, an inserting direction S1 and an inserting direction S2 are illustrated in FIG. 5. The inserting direction S1 is a direction in which the first harness connecting portion 152A is inserted into the second connecting portion 602A. The inserting direction S2 is a direction in which the second harness connecting portion 152B is inserted to the third connecting portion 603A. In an example of FIG. 5, the inserting direction S1 and the inserting direction S2 are the same direction. Note that the pair of the harnesses 152 may be attachable to and detachable from the charger 100.

### Internal configuration of charger

FIG. 6 is a circuit diagram inside the charger 100. As described using FIG. 1, the charger 100 includes the first connector 601, the second connector 602, the third connector 603, the pair of the power lines 151, the pair of the harnesses 152, and the like. The charger 100 also includes first nodes 102A, a first power switching assembly 301, an electronic control unit (ECU) 320, the converting circuit 180, and the supply circuit 190. In addition, the vehicle 10 includes the battery 106 (see FIG. 1) and an electric load 104. Note that in FIG. 6, the fourth connector 604 is not illustrated.

The ECU 320 may identify whether the voltage input to the first connector 601 from the charging station 14 is the AC voltage or the DC voltage. For example, the charging station 14 sends a voltage type signal indicating that the voltage input to the first connector 601 is the AC voltage or the DC voltage to the ECU 320. The ECU 320 may identify whether the AC voltage or the DC voltage is to be supplied based on this voltage type signal.

A pair of power lines 350 is power lines connecting the first connector 601 to the battery 106. That is, one end portions of the pair of the power lines 350 are connected to the first connector 601, and the other end portions of the pair of the power lines 350 are connected to the battery 106. The pair of the power lines 350 is a pair of a high voltage power line 350H through which a high voltage current flows and a low voltage power line 350L through which a low voltage current flows. The pair of the power lines 350 corresponds to the "first power line" of the present disclosure.

The supply circuit 190 is provided on the pair of the power lines 350. The supply circuit 190 supplies the DC power supplied to the first connector 601 to the battery 106. The supply circuit 190 has the pair of the power lines 350, second nodes 102B, third nodes 102C, a second power switching assembly 302, and a third power switching assembly 303.

The second nodes 102B are interposed between the first nodes 102A and the battery 106. The third nodes 102C are interposed between the second nodes 102B and the battery 106.

Power lines branches off from the pair of the power lines 350 at the first nodes 102A. The branching power lines are the above-described pair of the power lines 151. One end portions of the pair of the power lines 151 are connected to the first nodes 102A, and the other end portions of the pair of the power lines 151 are connected to the second connector 602. The first nodes 102A and the pair of the power lines 151 are accommodated in the second accommodating portion 702. The pair of the power lines 151 corresponds to the "second power line" of the present disclosure.

Furthermore, as described using FIG. 4 and other drawings, the second connector 602 and the third connector 603 are connected to each other by the pair of the harnesses 152. In addition, a current flowing through the third connector 603 is input to the converting circuit 180. As described below, the harnesses 152 are attachable and detachable in the present embodiment.

Power lines branches off from the pair of the power lines 350 at the second nodes 102B. The branching power lines are connected to the electric load 104. The electric load 104 is a load that generates driving power for the vehicle 10 using a power from the battery 106. The electric load 104 is, for example, a traction inverter.

Power lines branches off from the pair of the power lines 350 at the third nodes 102C. The branching power lines 351 are connected to the converting circuit 180.

One power switching assembly includes a high voltage relay that is provided on the high voltage power line and a low voltage relay that is provided on the low voltage power line. For example, the first power switching assembly 301 includes a high voltage relay 301H and a low voltage relay 301L. The first power switching assembly 301 is provided between the pair of the power lines 350 and an output side of the converting circuit 180. The second power switching assembly 302 is provided between the first nodes 102A and the second nodes 102B. The third power switching assembly 303 is provided between the second nodes 102B and the third nodes 102C.

In the present disclosure, “set the power switching assembly in an open state” means “set both the high voltage relay and the low voltage relay in the power switching assembly in an open state”. When the power switching assembly is set in the open state, a current cannot flow through the power switching assembly. On the other hand, “set the power switching assembly in a closed state” means “set both the high voltage relay and the low voltage relay in the power switching assembly in a closed state”. When the power switching assembly is set in the closed state, a current can flow through the power switching assembly.

Note that the third power switching assembly 303 includes a relay 303H, a relay 303L, and a relay 303P connected in series to a resistor. For example, when a capacitor of the electric load 104 is pre-charged at a startup of the vehicle 10, the charger 100 sets the relay 303H and the relay 303P in the closed state. This reduces the current due to the resistor connected to the relay 303P, so that it is suppressed that an inrush current flows into the capacitor of the electric load 104.

The ECU 320 performs control of the charging from an external power supply, control of the open/closed states of a plurality of the power switching assemblies, and the like. The ECU 320 is also referred to as the “control circuit”.

### Control of ECU 320

Next, the control of the ECU 320 will be described. As described above, the ECU 320 performs the control of the open/closed states of the plurality of the power switching assemblies, and the like. This sets the vehicle 10 (charger 100) in any of a plurality of states. The plurality of the states includes a battery discharging state, an AC charging state, and a DC charging state.

First, the battery discharging state will be described. The battery discharging state is a state in which the battery 106 is discharged, for example, a state in which the vehicle 10 is driven (travels). The ECU 320 sets the first power switching assembly 301 in the closed state, sets the second power switching assembly 302 in the open state, and sets the third power switching assembly 303 in the closed state, thereby setting the charger 100 in the battery discharging state.

In the battery discharging state, the power from the battery 106 is applied to the electric load 104.

Next, the AC charging state will be described. The AC charging state is a state in which the battery 106 is charged by the AC voltage supplied from the first connector 601. When the ECU 320 identifies that the AC voltage is supplied from the charging station 14, the ECU 320 sets the second power switching assembly 302 in the open state and sets the first power switching assembly 301 and the third power switching assembly 303 in the closed states.

Note that either the second power switching assembly 302 or the third power switching assembly 303 only needs to be set in the open state. Furthermore, when both the second power switching assembly 302 and the third power switching assembly 303 are set in the open state, it is suppressed that power is inadvertently supplied to the electric load 104.

In the AC charging state, the AC power supplied from the first connector 601 is input to the converting circuit 180 through the second connector 602 and the third connector 603. The converting circuit 180 converts the AC power to the DC power and supplies the converted DC power to the battery 106.

Next, the DC charging state will be described. When DC charging is performed, the ECU 320 sets the first power switching assembly 301 in the open state and sets the second power switching assembly 302 and the third power switching assembly 303 in the closed states. This supplies the DC power supplied from the first connector 601 to the battery 106.

As described above, the ECU 320 sets the second power switching assembly 302 in the open state for the AC charging state, whereas the ECU 320 sets the second power switching assembly 302 in the closed state for the DC charging state. In the charger 100 of the present embodiment, the battery 106 may be charged by such control, even when any of the AC power and the DC power is input to the first connector 601.

(1) The charger 100 of the present embodiment is applied to the vehicle (hereinafter, also referred to as the “common charging port vehicle”) with the charging port 12 being a common charging port that serves as the AC charging port and the DC charging port. However, the charger 100 is also applicable to the vehicle (hereinafter, also referred to as the “separate charging port vehicle”) with the AC charging port and the DC charging port provided separately.

When the charger 100 is applied to the separate charging port vehicle, the harnesses 152 are not used, and the second connector 602 is covered with a cover. The wiring extending from the AC charging port of the vehicle 10 is connected to the third connector 603, and the wiring extending from the DC charging port of the vehicle 10 is connected to the first connector 601. In addition, the charger 100 may be slightly modified by removing the power lines 151 and the second connector 602. Thus, when the charger 100 is applied to the separate charging port vehicle, the charger 100 in FIG. 3 may be applied to the separate charging port vehicle. In this case, the charger that is slightly modified by removing the power lines 151 and the second connector 602 may be applied to the separate charging port vehicle.

That is, even when the charger 100 is applied to any of the common charging port vehicle and the separate charging port vehicle, a large part of the charger 100 may be commonly applicable. Accordingly, in a case where the charger for the separate charging port vehicle and the charger for the common charging port vehicle are designed and manufactured, the charger 100 in the present embodiment may be reduced in the designing costs and manufacturing costs.

Moreover, the existing charger 100X is mounted in the engine compartment of the vehicle. In addition to the charger 100X, other components are also mounted in the engine compartment. As described above, the connector 603X is disposed in the side surface 100A of the charger 100X. Accordingly, when applying the charger 100X to the vehicle having the common charging port that serves as the AC charging port and the DC charging port, the designer of the charger or others may want to change the position of the connector 603X at which the cables are connected in the above-described existing charger in consideration of the presence of the other components. In addition, in order to apply the charger 100X to the common charging port vehicle, the designer of the charger and others may want to provide the supply circuit that is the path for the DC voltage when the DC voltage is supplied from the charging station 14 in the charger 100X.

However, when the charger with the connector located at the new position is manufactured as the new charger or the supply circuit is provided in the charger, it is necessary to significantly change the design for the electronic component layouts or the like inside the existing charger, which may cause the problem that the manufacturing costs of the new charger is increased.

In contrast, in the present embodiment, the charger for the common charging port vehicle and the charger for the separate port vehicle have the same position of the third connector 603 as described above. In addition, even when the supply circuit is provided, the charger for the common charging port vehicle and the charger for the separate port vehicle have the same position of the first connector 601. Accordingly, as described above, the present embodiment provides the charger 100 that is reduced in the manufacturing costs for the reason such that a significant design change of the electronic component layouts or the like inside the charger is not required.

(2) As illustrated in FIG. 4 and other drawings, the charger 100 includes the harnesses 152.

With this configuration, the charger 100 may supply the power from the second connector 602 (second connecting portion 602A) to the third connector 603 (third connecting portion 603A), and further supply the power from the third connector 603 (third connecting portion 603A) to the converting circuit 180.

(3) As illustrated in FIG. 5, the inserting direction S1 in which the first harness connecting portion 152A is inserted into the second connecting portion 602A is the same as the inserting direction S2 in which the second harness connecting portion 152B is inserted into the third connecting portion 603A.

With this configuration, a worker can easily insert the first harness connecting portion 152A to the second connecting portion 602A and insert the second harness connecting portion 152B to the third connecting portion 603A, as compared with the charger in which the inserting direction S1 and the inserting direction S2 are different from each other.

Note that in the present disclosure, the wording that one direction (hereinafter, also referred to as the “first direction”) and another direction (hereinafter, also referred to as the “second direction”) are the same may mean both that these directions are completely the same and that these directions are substantially the same. The wording of “substantially the same” may mean that the first direction and the second direction are allowed to be different from each other as long as the present embodiment provides the effect in relation to the first direction and the second direction. For example, the wording that the inserting direction S1 and the inserting direction S2 are substantially the same means that the inserting direction S1 and the inserting direction S2 are allowed to be different from each other as long as the present embodiment provides the effect that “the worker can easily insert the first harness connecting portion 152A to the second connecting portion 602A and insert the second harness connecting portion 152B to the third connecting portion 603A”.

(4) As illustrated in FIG. 3, the second connecting portion 602A and the third connecting portion 603A are disposed in the first surface 660A of the case 660.

With this configuration, the worker can easily insert the first harness connecting portion 152A to the second connecting portion 602A and insert the second harness connecting portion 152B to the third connecting portion 603A, as compare with a configuration in which the second connecting portion and the third connecting portion are disposed on different surfaces.

(5) As illustrated in FIG. 3, the first connecting portion 601A is disposed in the second surface 660B of the case 660.

With this configuration, the first connecting portion 601A, the second connecting portion 602A, and the third connecting portion 603A may be grouped into two sets, and the two sets may be disposed in the different surfaces. Accordingly, a degree of freedom of layouts of the connecting portions is improved, as compared with a configuration in which the first connecting portion, the second connecting portion, and the third connecting portion are disposed in one surface.

(6) As illustrated in FIG. 3, in the mounted state in which the charger 100 is mounted on the vehicle 10, the first surface 660A is the side surface, and the second surface 660B is the upper surface.

If the charger has a configuration in which the first connecting portion 601A is disposed in a side surface of the charger, when the cables 160 are inserted into the first connecting portion 601A and a force along the side surface caused by the driving of the vehicle 10 is applied to the cables 160, the cables 160 may come off from the first connecting portion 601A. On the other hand, in the present embodiment, the first connecting portion 601A is disposed in the second surface 660B being the upper surface, so that even when a force along the side surface is applied to the cables 160, it is suppressed that the cables 160 come off from the first connecting portion 601A.

(7) As illustrated in FIG. 3, the charger 100 includes the first connector-cover 601B, the second connector-cover 602B, and the third connector-cover 603B. The first connector-cover 601B covers the first connecting portion 601A and is waterproof. The second connector-cover 602B covers the second connector-cover 602A and is waterproof. The third connector-cover 603B covers the third connecting portion 603A and is waterproof. With this configuration, a waterproof performance of each of the first connecting portion 601A, the second connecting portion 602A, and the third connecting portion 603A is enhanced.

(8) As illustrated in FIG. 3, the first connecting portion 601A, the second connecting portion 602A, and the third connecting portion 603A are disposed in the case 660 together with the first connector-cover 601B, the second connector-cover 602B, and the third connector-cover 603B, respectively so that a part of each of them is exposed on the outside of the charger 100.

If the connecting portions are disposed inside the charger, it is necessary to form holes in the case and allow the cables or the like to pass through the holes. In this case, foreign matters may enter the case through the holes. In contrast, in the configuration of the present embodiment, the connecting portions are disposed in the case 660 so that a part of each of the connecting portions is exposed on the outside the charger 100, which suppresses that foreign matters enter the case 660 through the above-described holes.

(9) As illustrated in FIG. 3, the third connecting portion 603A is disposed in the first accommodating portion 701. The first connecting portion 601A and the second connecting portion 602A are disposed in the second accommodating portion 702.

With this configuration, in a case where the above-described existing charger 100X is the first accommodating portion 701, the charger 100 of the present embodiment is provided by fixing the second accommodating portion 702 to the first accommodating portion 701. Thus, the present embodiment provides the charger 100 that is reduced in the manufacturing costs.

(10) The first accommodating portion 701 and the second accommodating portion 702 are separable from each other.

For example, the power lines 151 and the second connector 602 may not be required due to a design change for the separate charging port vehicle on which the charger 100 is mounted, or the like. Even in such a case, the designer can replace the second accommodating portion 702 with another second accommodating portion from which the power lines 151 and the second connector 602 are removed. Accordingly, the designer can easily and slightly modify the charger 100 by removing the power lines 151 and the second connector 602.

(11) When the DC power is supplied to the first connecting portion 601A, a voltage that is greater than 0 V and 1000 V or less is supplied to the first connecting portion 601A, whereas when the AC power is supplied to the first connecting portion 601A, a voltage that is greater than 0 Vrms and 293 Vrms or less is supplied to the first connecting portion 601A.

With this configuration, even when the above-described voltage is supplied to the first connecting portion 601A, the battery 106 is properly charged.

### Modification

In the above-described embodiment, the configuration in which all of the first connecting portion 601A, the second connecting portion 602A, and the third connecting portion 603A have the corresponding connector-covers is described. However, a configuration that one of the first connecting portion 601A, the second connecting portion 602A, and the third connecting portion 603A has the connector-cover may be adopted. Alternately, a configuration that any two of the first connecting portion 601A, the second connecting portion 602A, and the third connecting portion 603A have the corresponding connector-covers may be adopted.

### Supplementary notes

(Item 1) A charger of the present disclosure is mounted on a vehicle. The charger has a converting circuit, a supply circuit, a case, a first connecting portion, a second connecting portion, and a third connecting portion. The converting circuit converts an AC power supplied from a charging equipment outside the vehicle to a DC power and supplies the converted DC power to a battery of the vehicle. The supply circuit supplies a DC power supplied from the charging equipment to the battery and is provided on a first power line that connects the first connecting portion to the battery. The converting circuit and the supply circuit are accommodated in the case. The first connecting portion is disposed in the case and a cable through which the AC power or the DC power from the charging equipment outside the vehicle is supplied to the first connecting portion is connected to the first connecting portion. The second connecting portion is disposed in the case and is formed so that the power supplied to the first connecting portion and passing through a second power line branching off from the first power line is output. The third connecting portion is disposed in the case and connected to the converting circuit.

With this configuration, in a case where a charger for a vehicle with an AC charging port and an DC charging port provided separately and a charger for a vehicle with a common charging port that serves as the AC charging port and the DC charging port are designed and manufactured, the present disclosure provides the charger that is reduced in designing costs and manufacturing costs.

(Item 2) The charger according to item 1 further includes a harness. A first harness connecting portion is formed at one end of the harness, and a second harness connecting portion is formed at the other end of the harness. The first harness connecting portion is connected to the second connecting portion, and the second harness connecting portion is connected to the third connecting portion. The second connecting portion is formed so that the power supplied to the first connecting portion is output to the harness through the second connecting portion, and the third connecting portion is formed so that the power supplied from the second connecting portion is supplied to the converting circuit through the third connecting portion.

With this configuration, the power from the second connecting portion may be supplied to the third connecting portion, and furthermore, the power from the third connecting portion may be supplied to the converting circuit.

(Item 3) In the charger according to item 2, an inserting direction in which the first harness connecting portion is inserted into the second connecting portion is the same as an inserting direction in which the second harness connecting portion is inserted into the third connecting portion.

With this configuration, a worker can easily insert the first harness connecting portion to the second connecting portion and insert the second harness connecting portion to the third connecting portion, as compared with a charger in which an inserting direction in which the first harness connecting portion is inserted into the second connecting portion and an inserting direction in which the second harness connecting portion is inserted into the third connecting portion are different from each other.

(Item 4) In the charger according to any one of items 1 to 3, the case has a first surface. In addition, the second connecting portion and the third connecting portion are disposed in the first surface.

With this configuration, the worker can easily insert the first harness connecting portion to the second connecting portion and insert the second harness connecting portion to the third connecting portion, as compared with a configuration in which the second connecting portion and the third connecting portion are disposed on different surfaces.

(Item5) In the charger according to item 4, the case has a multi-sided structure including the first surface and a second surface different from the first surface. The first connecting portion is disposed in the second surface.

With this configuration, the first connecting portion, the second connecting portion, and the third connecting portion may be grouped into two sets, and the two sets may be disposed in the different surfaces. Accordingly, a degree of freedom of layouts of the connecting portions is improved, as compared with a configuration in which the first connecting portion, the second connecting portion, and the third connecting portion are disposed in one surface.

(Item 6) In the charger according to item 5, the first surface is a side surface and the second surface is an upper surface in a mounted state in which the charger is mounted on the vehicle.

If the charger has a configuration in which the first connecting portion is disposed in a side surface, when the cable is inserted into the first connecting portion and a force along the side surface caused by the driving of the vehicle is applied to the cable, the cable may come off from the first connecting portion. On the other hand, in the present embodiment, the first connecting portion is disposed in the upper surface, so that even when a force along the side surface is applied to the cables, it is suppressed that the cable comes off from the first connecting portion.

(Item 7) The charger according to any one of items 1 to 6 further includes a connector-cover that covers at least one of the first connecting portion, the second connecting portion, and the third connecting portion and is waterproof.

With this configuration, a waterproof performance of the at least one of the first connecting portion, the second connecting portion, and the third connecting portion is enhanced.

(Item 8) In the charger according to item 7, the at least one of the connecting portions is disposed in the case together with the corresponding connector-cover so that a part of the at least one of the connecting portions is exposed on an outside of the charger.

If at least one of the connecting portions is disposed inside the charger, it is necessary to form a corresponding hole in the case and allow the cable or the like to pass through the hole. In this case, foreign matters may enter the case through the hole. In contrast, in this configuration, the at least one of the connecting portions is disposed in the case so that a part of the at least one of the connecting portions is exposed on the outside the case, which suppresses that foreign matters enter the case through the above-described hole.

(Item 9) In the charger according to any one of items 1 to 8, the case has a first accommodating portion in which the converting circuit is accommodated and a second accommodating portion in which the second power line is accommodated and that is positioned on the first accommodating portion. The third connecting portion is disposed in the first accommodating portion. The first connecting portion and the second connecting portion are disposed in the second accommodating portion.

With this configuration, in a case where the above-described existing charger is the first accommodating portion, the charger in the present disclosure is provided by causing the second accommodating portion to be positioned on the first accommodating portion. Thus, the present disclosure provides the charger that is reduced in the manufacturing costs.

(Item 10) In the charger according to item 9, the first accommodating portion and the second accommodating portion are separable from each other.

For example, the second connector may not be required because of a design change for the vehicle on which the charger is mounted, or the like. Even in such a case, the designer or others can separate the second accommodating portion from the first accommodating portion. As a result, the designer or the others can easily and slightly modify the charger, for example, by replacing the second accommodating portion with another second accommodating portion from which the second connecting portion is removed.

(Item 11) In the charger according to any one of items 1 to 10, when the DC power is supplied to the first connecting portion, a voltage that is greater than 0 V and 1000 V or less is supplied to the first connecting portion, and when the AC power is supplied to the first connecting portion, a voltage that is greater than 0 Vrms and 293 Vrms or less is supplied to the first connecting portion.

With this configuration, even when the above-described voltage is supplied to the first connecting portion, the battery is properly charged.

The embodiments disclosed herein are examples in all respects, and should not be considered restrictive. The scope of the present disclosure shall be defined not by the above-described embodiments but by the claims, and is intended to include embodiments equivalent to the scope of the claims and all modifications within the scope.

What is claimed is:

1. A charger mounted on a vehicle, the charger comprising:
a converting circuit that converts an AC power supplied from a charging equipment outside the vehicle to a DC power and supplies the converted DC power to a battery of the vehicle;
a supply circuit that supplies a DC power supplied from the charging equipment to the battery;
a case in which the converting circuit and the supply circuit are accommodated; and
a first connecting portion that is disposed in the case and to which a cable is connected,
the AC power or the DC power from the charging equipment outside the vehicle being supplied to the first connecting portion though the cable, and
the supply circuit being provided on a first power line that connects the first connecting portion to the battery, wherein
the charger further includes:
a second connecting portion that is disposed in the case and from which the power supplied to the first connecting portion and passing through a second power line branching off from the first power line is output; and
a third connecting portion that is disposed in the case and connected to the converting circuit.

2. The charger according to claim 1, further comprising a harness, wherein
a first harness connecting portion is formed at one end of the harness,
a second harness connecting portion is formed at the other end of the harness,
the first harness connecting portion is connected to the second connecting portion,
the second harness connecting portion is connected to the third connecting portion,
the second connecting portion is formed so that the power supplied to the first connecting portion is output to the harness through the second connecting portion, and
the third connecting portion is formed so that the power supplied from the second connecting portion is supplied to the converting circuit through the third connecting portion.

3. The charger according to claim 2, wherein
an inserting direction in which the first harness connecting portion is inserted into the second connecting portion is the same as an inserting direction in which the second harness connecting portion is inserted into the third connecting portion.

4. The charger according to claim 1, wherein
the case has a first surface, and
the second connecting portion and the third connecting portion are disposed in the first surface.

5. The charger according to claim 4, wherein
the case has a multi-sided structure including the first surface and a second surface different from the first surface, and
the first connecting portion is disposed in the second surface.

6. The charger according to claim 5, wherein
the first surface is a side surface and the second surface is an upper surface in a mounted state in which the charger is mounted on the vehicle.

7. The charger according to claim 1, further comprising a connector-cover that covers at least one of the first connecting portion, the second connecting portion, and the third connecting portion and is waterproof.

8. The charger according to claim 7, wherein
the at least one of the connecting portions is disposed in the case together with the corresponding connector-cover so that a part of the at least one of the connecting portions is exposed on an outside of the charger.

9. The charger according to claim 1, wherein
the case has:
a first accommodating portion in which the converting circuit is accommodated; and
a second accommodating portion in which the second power line is accommodated and that is positioned on the first accommodating portion,
the third connecting portion is disposed in the first accommodating portion, and
the first connecting portion and the second connecting portion are disposed in the second accommodating portion.

10. The charger according to claim 9, wherein
the first accommodating portion and the second accommodating portion are separable from each other.

11. The charger according to claim 1, wherein
when the DC power is supplied to the first connecting portion, a voltage that is greater than 0 V and 1000 V or less is supplied to the first connecting portion, and
when the AC power is supplied to the first connecting portion, a voltage that is greater than 0 Vrms and 293 Vrms or less is supplied to the first connecting portion.
